(19) United States
(12) Patent Application Publication
(10) Pub. No.: US 2016/0269295 A1
(43) Pub. Date: Sep. 15, 2016

(54) NETWORK TRAFFIC CLASSIFICATION AND REDIRECTION

(71) Applicant: HEWLETT PACKARD ENTERPRISE DEVELOPMENT LP, Houston, TX (US)

(72) Inventors: Pramod Kumar A S, Bangalore (IN); Suddha Sekhar DEY, Roseville, CA (US)

(21) Appl. No.: 15/031,741

(22) PCT Filed: Oct. 24, 2013
(86) PCT No.: PCT/US2013/066544

§ 371 Date: Apr. 24, 2016

(51) Int. Cl. H04L 12/803; H04L 12/26; H04L 12/813

(52) U.S. Cl. CPC H04L 47/125; H04L 47/20; H04L 43/0888

(57) ABSTRACT

Network traffic classification and redirection can include classifying incoming network traffic based on a rate of the incoming network traffic, and in response, redirecting the incoming network traffic.

### BACKGROUND

Network traffic flow includes a sequence of network packets, e.g., network traffic, traveling from a source device to a destination device. As applications such as voice, video, and data appear on converging network, the need for more control over network traffic has increased. For example, uniform and efficient traffic-handling through the network has become important, including keeping prioritized traffic moving at an acceptable speed, regardless of a current bandwidth usage.

### BRIEF DESCRIPTION OF THE DRAWINGS

FIG. 1 illustrates an example network according to the present disclosure.

FIG. 2 illustrates a flow chart of an example of a method for network traffic classification and redirection according to the present disclosure.

FIG. 3 illustrates a flow chart of an example of a method for network traffic classification and redirection according to the present disclosure.

FIGS. 3A-3B illustrate examples of systems for network traffic classification and redirection according to the present disclosure.

### DETAILED DESCRIPTION

Network traffic control includes managing, prioritizing, and/or controlling network traffic. Network traffic control can be used to control Internet bandwidth and to reduce congestion, latency, and network packet loss. As applications such as voice, video, and data appear on converging networks, the importance of control over network traffic has increased.

Network traffic control can include a number of actions supported by metering, e.g., using a switch element that can measure and control the rate of network packets. Metering can trigger particular actions within a network, for instance. Actions supported by metering can include, for example, dropping network packets, e.g., “drop action”, and differentiated service code point (DSCP) remark, e.g., “DSCP remark action”, that remarks network packets that had been marked previously. Network traffic control, classification, and redirection in accordance with the present disclosure can, in addition to performing a drop action and/or a DSCP remark, perform a “redirect” action, which can redirect, e.g., forward, incoming network traffic to specified network interfaces, e.g. ports, data ports, virtual local area networks (VLANs), etc., based on the rate, e.g., flowing through a network device, of the incoming network traffic. The rate of incoming network traffic, e.g., through an interface of a network device, can be expressed, for example, as network packets per second or bytes per second, among others. For instance, the rate of incoming network traffic can include the rate, e.g., in network packets per second, that the network traffic flows through an interface, e.g., port, VLAN, of the network device.

By doing so, network traffic redirection and classification in accordance with the present disclosure can increase uniformity and efficiency of network traffic handling. Network traffic can be redirected to particular locations, e.g., via network interfaces, based on the rate of the network traffic. By making network redirection decisions, e.g., forwarding decisions, based on the rate of the incoming network traffic into a network device, e.g., switch, router, etc., instead of or in addition to using policies set by a network administrator, improved load balancing can be achieved. A network administrator may have increased control over network traffic flowing through switches and other components in the network. In addition, network traffic classification and redirection based on the network traffic rate, e.g., prioritization via the network traffic rate, can keep network traffic deemed important moving at a speed deemed acceptable, regardless of current bandwidth usage. As used herein, “rate of network traffic” and “network traffic rate” are used interchangeably.

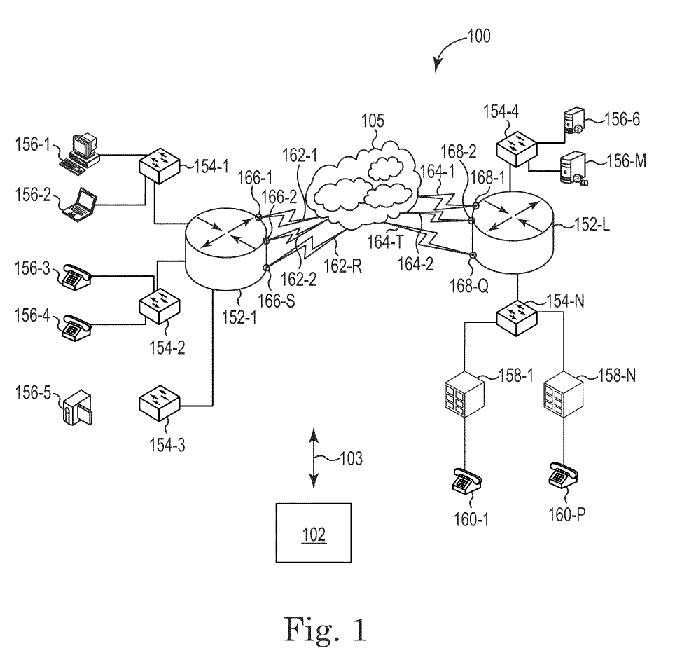

FIG. 1 illustrates an example network 100 according to the present disclosure. The network 100 can include the devices illustrated in FIG. 1, e.g., all of the devices illustrated in FIG. 1, and can be a combination of a Layer 2 and a Layer 3 network. Network 100 can include a network controller 102. In some examples, the network controller 102 can include a software-defined networking (SDN) network controller. SDN is a form of network virtualization in which the control plane is separated from the data plane and implemented in a software application. Network administrators can therefore have programmable centralized control of network traffic without requiring physical access to the network's hardware devices. In some examples, the network controller 102 can be a discrete device, such as a server. In some examples, the network controller 102 can be a distributed network controller, for example, such as a cloud-provided functionality.

One example of a protocol for SDN is OpenFlow, which is a communications protocol that gives access to the forwarding plane of a network switch over the network. OpenFlow can allow a path of network packets through a network of network devices, e.g., switches, to be determined by instructions executable by a processing resource and running on a plurality of network devices, e.g., routers. Some examples of the present disclosure can operate according to an Open Flow, or other SDN protocol, and/or a hybrid of an SDN protocol combined with “normal,” e.g., distributed control plane, networking.

The network controller 102 can be in communication with and/or have control over network devices 154-1, 154-2, 154-3, 154-4, . . . , 154-N (herein referred to as “154”) and network devices 152-1, . . . , 152-L (herein referred to as “152”). For example, network devices 152, 154 can be switches, distribution switches, routers, hubs, and/or bridges, among other devices and/or hops. Examples are not limited to the specific number of network devices 152, 154 illustrated in the network 100.

The network controller 102 and the network devices 152, 154 can be in communication using a communication protocol 103 that can include a communication link between the network controller 102 and the network devices 152,154 using a secure channel. The communication protocol 103, in various examples, can include an OpenFlow protocol. As an example, the network controller 102 can use the communication protocol 103 to manage the network devices 152, 154.

The network controller 102 can receive network traffic, e.g., data units pass directly through the network controller 102. The network controller 102 can perform, e.g., run, a function to construct a data path for traffic flows in the network 100. Data paths, as used herein, can include route paths, e.g., among network devices 152, 154, of incoming data units to an end device, e.g., device that a data unit ends at and/or endpoint of a data path. In various examples, as illustrated by the example of FIG. 1, an end device can include a host device 156-1, . . . 156-M (herein referred to as “156”), 158-1, . . . , 158-N (herein referred to as “158”), and 160-1, . . . , 160-P (herein referred to as “160”), e.g., a desktop computer, a laptop computer, a tablet computer, a telephone, a private branch exchange, and/or a mobile device, among others. The data path, e.g., between network devices 152, 154, and end devices 156, 158, 160, for traffic flows can be determined proactively, e.g., before the data units arrive at the network controller 102, and/or reactively, e.g., as the data unit and/or new data unit arrives at the network controller 102.

An example data path, as illustrated in the example of FIG. 1, can include a data unit sent from a first host device, e.g., device 156-1. The first host device 156-1 can send the data unit to the network controller 102 via a communication link. The data path can include a path among the plurality of network devices 152, 154 to a host end device. Of note, the network devices 152, 154 are indicative of any number of network devices 152, 154 there between depending on the size of the network 100. Although not specifically illustrated as such, an end device can alternatively be a server and/or a switch, rather than a host device.

A network device can communicate with other network devices, e.g., particular network device based on interconnections and/or with host devices using communication links within the network. The communication links, e.g., between network devices and host devices, and/or the communication protocol 103, can include secure channels.

The network controller 102 can include a processing resource in communication with a memory resource. The memory resource can include instructions executable by the processing resource to perform a number of functions described herein. For example, the network controller 102 can redirect network traffic. The controller 102 can include software, hardware, and/or logic to perform a number of functions as described herein. For example, the controller 102 can be a system such as system 409 and/or a computing device such as computing device 418 as referenced in FIGS. 4A-4B. That is, the controller 102 can include hardware and/or a combination of hardware and programming to redirect network traffic.

Example network 100 can include a network device, e.g., switch 154-1, coupled to a different network device, e.g., router 152-1, comprising a plurality of network interfaces, e.g., 166-1, . . . , 166-S (herein referred to as “166”). In the example network, the router 152-1 can redirect incoming network traffic to a network interface, e.g., network interface 166-1, within the plurality of network interfaces 166 based on the rate of the incoming traffic. The network interfaces 166, 168 can be ingress and/or egress interfaces and can be located at a number of different locations of network devices 152. The network interfaces 166, 168 are not limited to the locations illustrated in FIG. 1. Network device 152-1 can forward the redirected incoming network traffic to the switch 154-1 via the network interface 166-1 of the plurality of network interfaces 166. A similar method includes the use of network device 154-4, network device 152-L, and interface 168-1, for instance.

In such examples, incoming network traffic can be classified using a content addressable memory (CAM), e.g., a ternary content addressable memory (TCAM), as will be discussed further herein. In contrast to other memory, e.g., random access memory (RAM), in which an operating system provides an address and receives data stored at a memory, CAM is supplied the data, and the CAM returns a list of addresses where the data is stored if the data matches the content in the list of addresses. A CAM can search an entire memory in one operation, in some instances.

A TCAM can perform as a binary CAM, e.g., search for ones and zeros, as well as allowing for an operating system to match a third state, e.g., an “X” state which can also be referred to as “don't care.” The X state can be a “mask”, meaning its value can be anything.

Network devices can store entire routing tables in these TCAMs, allowing for faster lookups as compared to other memory. A TCAM can include an application-specific integrated circuit (ASIC), for example.

Ternary CAMs can be used in network devices, e.g. network devices 152, 154, where each IP address has two parts: the network address, which can vary in size depending on a subnetwork configuration, and the host address, which occupies remaining bits. Each subnetwork may have a network mask that specifies which bits of the address are the network address and which bits are the host addresses. Routing can be performed by consulting a routing table maintained by the network device which contains each known destination network address, the associated network mask, and the information needed to route network packets to that destination. Without CAM/TCAM, a network device may have to compare the destination address of the network traffic packet to be routed with each entry in the routing table, performing a logical AND with the network mask, and comparing it with the network address. If they are equal, the corresponding routing information is used to forward the network traffic packet. Using a TCAM for the routing table increases the efficiency of the lookup process. The addresses are stored using “mask” for the host part of the address, so looking up the destination address in the TCAM can immediately retrieve the correct routing entry.

As noted, in a number of examples of network traffic classification and redirection, the TCAM can classify the incoming network traffic based on different criteria, as will be discussed further herein. For instance, streaming video can be classified based on a protocol. Fields in a network traffic header, e.g., packet header can define the network traffic, e.g., packet, type. In response to the classification, the TCAM can take specific actions on the classified traffic. Actions can include dropping traffic, forwarding traffic, redirecting traffic, metering traffic, and changing fields in a network packet header, for example.

In some instances, a TCAM can apply a network traffic policer to the traffic entering a network interface. A TCAM can apply a policer to the traffic, e.g., all of the traffic, or a subset of the traffic entering network interface, e.g., incoming network traffic. The flow can be determined, e.g., a classification can be made, by a combination of different fields in a packet header, e.g., a network traffic header, such as, for example, source internet protocol (IP), destination IP, L4 source and destination interfaces, source and destination MAC addresses, VLAN, DSCP value, etc. Traffic policing can include monitoring network traffic for compliance with a network traffic contract and taking steps to enforce that contract. The network traffic policer, which can be a particular, e.g., special, kind of meter, can take actions such as, for example, drop the traffic, rewrite a network traffic packet's DSCP value, and/or write a value in switch metadata for traffic conforming, exceeding, or violating the contract. A metadata can include a value that can be set by an ASIC block in the switch that is passed along with the packet between different ASIC blocks within the networking device. The scope of the metadata is within the networking device and is not exposed to the outside world. Network traffic rates can be exceeded and/or violated, resulting in different actions being taken in response to those network traffic rates. A network traffic contract can include, for example, information related to what kind of network traffic will be transported, and the performance requirements of that network traffic. This information can be presented by a service or application to the network.

In response to the classifications and/or actions performed by the TCAM, logic, e.g., a low-level dynamic hardware processing engine, can be used to add runtime rules into an ASIC that compares certain registers with given values, e.g., compare metadata values with register values, and can perform certain actions. One of the actions can include setting an egress network interface for incoming network traffic.

In some examples, a meter action (or return data) from the TCAM can set, e.g., choose, a metadata that can be sent to another ASIC in the switch pipeline. For instance, a TCAM entry can configure a quality of service policer and set a low-level dynamic hardware processing engine metadata bit. This can ensure the incoming network traffic is inspected by the low-level dynamic hardware processing engine. In a number of examples, marking a metadata to ensure the packet is processed by the low-level dynamic hardware processing unit can be part of a classification field in the TCAM. The TCAM can mark this specific field and send it to the low-level dynamic hardware processing engine, which can look at the metadata field set by the policer action and take an action depending on the value of the field, for instance.

The policer can set different metadata values for packets matching criteria set by the classification fields in the TCAM, e.g., three different metadata values, for conforming, e.g., meets commit rate, exceeding commit rate, and exceeding violated, e.g., peak, rate. The low-level dynamic hardware processing engine can be programmed to inspect the metadata values set by the policer and redirect traffic to different network interfaces, e.g., network interfaces 166, 168, depending on the metadata values.

A committed information rate, also known as a committed rate or a commit rate is an average bandwidth for a virtual circuit guaranteed by an internet service provider (ISP) to work under normal conditions. At any given time, the bandwidth should not fall below this committed figure. Above the committed information rate, an allowance of burstable bandwidth may be given, whose value can be expressed in terms of additional rate (known as the excess information rate) or as its absolute value (peak information rate or peak rate). The provider may guarantee that the connection will always support the committed information rate, and sometimes the excess information rate provided that there is adequate bandwidth. The peak information rate, e.g., the committed information rate plus excess information rate, is either equal to or less than the speed of the access network interface into the network.

For example, incoming network traffic meeting a commit rate can be redirected to a first network interface, e.g., network interface 166-1. Incoming network traffic exceeding the commit rate but not the peak rate can be redirected to a second network interface, e.g., network interface 166-2. Incoming network traffic exceeding a peak rate, e.g., peak network traffic rate, can be redirected to a third network interface, e.g., 166-S. In some examples, particular network interfaces can correspond to particular network bandwidths, e.g., a first network interface may correspond to a first bandwidth that is less than a second bandwidth corresponding to a second network interface. In a number of examples, the number of network interfaces can be more or less than three network interfaces.

In some examples, the TCAM policer can remark a network packet's DSCP value depending on the rate of network traffic flowing through a switch. For instance, a TCAM entry matching the packet flow can configure a policer and set the low-level dynamic hardware processing engine metadata bit. The policer can set different DSCP values, e.g., three different DSCP values, for conforming, exceeding, and violating traffic.

The low-level dynamic hardware processing engine can be programmed to inspect the DSCP values and redirect traffic to different network interfaces, e.g., network interfaces 166, 168 depending on the DSCP value. For example, incoming network traffic conforming to a commit rate can be redirected to first network interface, e.g., network interface 166-1. Incoming traffic exceeding the commit rate but not the peak rate can be redirected to a second network interface, e.g., network interface 166-2. Incoming network traffic exceeding a peak rate can be redirected to a third network interface, e.g., network interface166-S.

Controller 102 can accomplish load balancing using this “redirect” meter action. By redirecting traffic to different network interfaces, traffic conforming to a contract or high priority traffic can be given preferential treatment. For example, a network administrator at a university may desire to send voice over internet protocol (VoIP) traffic using a reliable link, e.g., assign a higher priority, before sending a streaming video from a student dorm which exceeds the limits over a less reliable link. Network traffic redirection and classification in accordance with the present disclosure can allow the university administrator to have the flexibility to implement his or her desired action, e.g., prioritize network traffic.

In another example, an organization may use a “pay if you use” model. The organization may pay extra money to use a high bandwidth network interface in such a model, e.g., communication links 162-1, 162-2, 162-R and 164-1, 164-2, 164-T may be links of different bandwidths, e.g., low-speed, medium-speed, high-speed, linked to the Internet 105. The network administrator of the organization may want to use the low speed link as much as possible, while only using the more expensive network interface, e.g., high speed, when absolutely necessary. Network traffic classification and redirection in accordance with the present disclosure can allow the network administrator of the organization to have the flexibility to implement his or her plan.

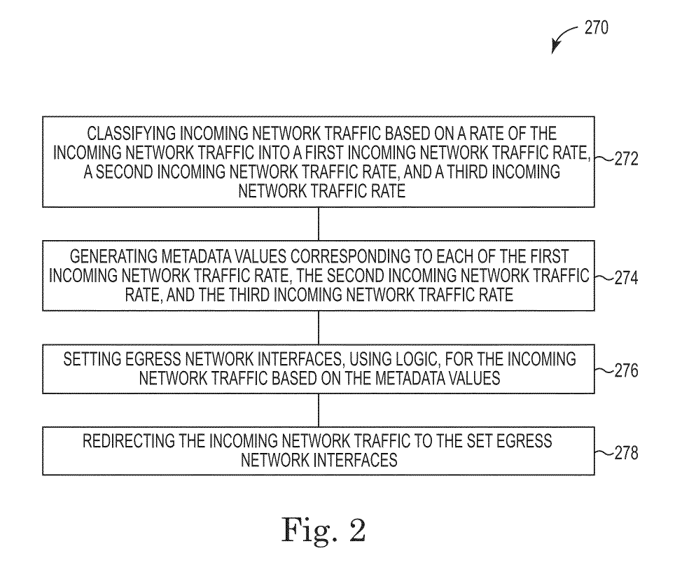

FIG. 2 illustrates a flow chart of an example of a method 270 for network traffic classification and redirection according to the present disclosure. Network traffic classification and redirection in accordance with the present disclosure and example method 270 can result in load balancing, e.g., distributed workloads, among other benefits. At 272, incoming network traffic is classified based on a network traffic rate of the incoming network traffic into a first incoming network traffic rate, a second incoming network traffic rate, and a third incoming network traffic rate. For example, the first incoming network traffic rate can include a network traffic rate meeting (or falling below) a commit rate. The second incoming network traffic rate can include a network traffic rate exceeding the commit rate, but falling below a peak rate. The third network traffic rate can include a network traffic rate exceeding the peak rate.

At 274, metadata values corresponding to each of the first incoming network traffic rate, the second incoming network traffic rate, and the third incoming network traffic rate are generated. The metadata values can be generated by a policer, for instance.

In a number of examples, a first metadata value corresponding to the first incoming network traffic rate can correspond to a value for conforming network traffic, e.g., meeting a commit rate. A second metadata value corresponding to the second incoming network traffic rate can correspond to a value for exceeding commit rate, e.g., exceed commit network traffic rate, but fall below peak rate. A third metadata value corresponding to the third incoming network traffic rate can correspond to a value for exceeding violated network traffic rate, e.g., exceeding peak rate.

At 276, egress network interfaces are set for the incoming network traffic based on the metadata values set by the meter, e.g., using logic. For instance, a first network interface can be set corresponding the first metadata value, a second network interface set corresponding to the second metadata value, and a third network interface set corresponding to the third metadata value. In some examples, each network interface can be associated with a different bandwidth.

The incoming network traffic is redirected to the set egress network interfaces at 278. The incoming network traffic can be redirected, via these egress network interfaces, to other network devices, e.g., switches, in the network, for example. This redirection can allow for load balancing and fine control over traffic flowing thorough network devices, as well as for prioritization of forwarding particular network traffic, e.g., according to a network contract.

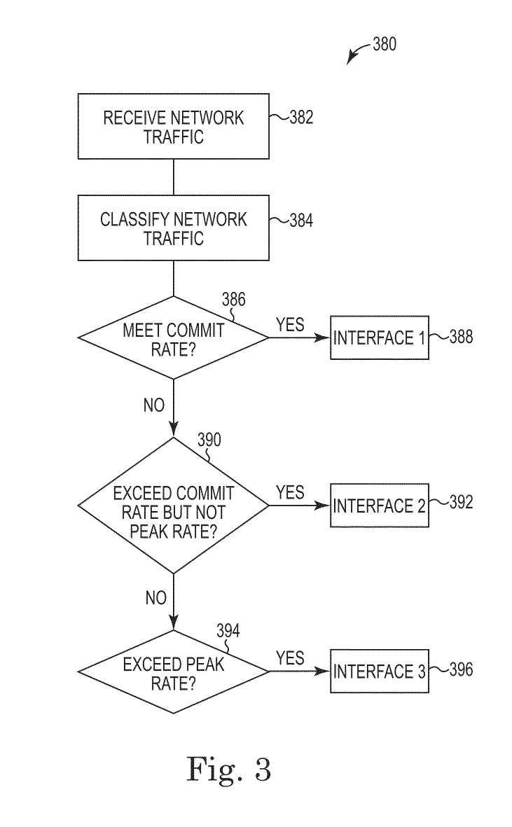

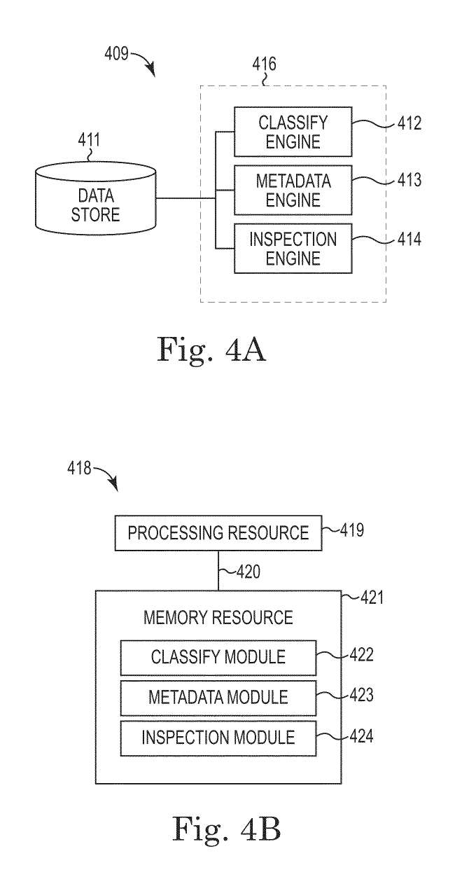

FIG. 3 illustrates a flow chart of an example of a method 380 for network traffic classification and redirection according to the present disclosure. At 382, network traffic is received, for example, at a network device, e.g., router, of a network. At 384, the received network traffic is classified. The network traffic can be classified, for example, using a TCAM. Classifications can include meeting commit network traffic rate, exceeding commit traffic but falling below peak rate, and exceeding peak rate. The classifications can be used to determine an egress network interface for received network traffic.

For example, at 386, it is determined whether the received network traffic meets a commit rate. In response to the received network traffic meeting (or falling below) the commit rate, it is redirected to a corresponding network interface, e.g., network interface 1, at 388.

At 390, it is determined whether the received network exceeds the commit rate, but falls below the peak rate. In response to the received network traffic exceeding the commit rate, but falling below the peak rate, it is redirected to a corresponding network interface, e.g., network interface 2, at 392.

At 394, it is determined that the received network exceeds the peak rate. In response to the received network traffic meeting or exceeding the peak rate, it is redirected to a corresponding network interface, e.g., network interface 3, at 396.

FIGS. 4A-4B illustrate examples of systems 409, 418 for network traffic classification and redirection according to the present disclosure. As illustrated in FIG. 4A, system 409 can include a data store 411, processing system 416, and/or engines 412, 413, and 414. The processing system 416 can be in communication with the data store 411 via a communication link, and can include the engines, e.g., classify engine 412, metadata engine 413, and inspection engine 414. The processing system 416 can include additional or fewer engines than illustrated to perform the various functions described herein.

The engines can include a combination of hardware and programming that is configured to perform a number of functions described herein, e.g., classifying and redirecting network traffic. The programming can include program instructions, e.g., software, firmware, etc., stored in a memory resource, e.g., computer readable medium, machine readable medium, etc., as well as hard-wired program, e.g., logic.

The classify engine 412 can include hardware and/or a combination of hardware and programming to classify incoming network traffic based on a rate of the incoming network traffic using a content-addressable memory (CAM), e.g., a TCAM having a policer. Classifications can correspond to particular network traffic rates, e.g., commit rate, peak rate, etc.

The metadata engine 413 can include hardware and/or a combination of hardware and programming to index, using the TCAM with a meter action, the classified network traffic into associated metadata values. For example, the CAM, e.g., TCAM, can override a metadata value. Different metadata values can be set for different network traffic rates, e.g., commit rate, exceed commit rate, exceed peak rate.

The inspection engine 414 can include hardware and/or a combination of hardware and programming to inspect the metadata values and redirect the network traffic to corresponding network interfaces based on the inspection. For example, a low-level dynamic hardware processing engine can be programmed to inspect metadata values, and redirect traffic to different network interfaces depending on the metadata values, e.g., depending on a network traffic rate.

In some instances, the system 409 can include an action engine (not illustrated in FIG. 4A). The action engine can include hardware and/or a combination of hardware and programming to apply a network policer to enforce the network traffic contract by marking separate metadata values for network traffic conforming to the network traffic contract, network traffic exceeding the network traffic contract, and network traffic violating the network traffic contract.

FIG. 4B illustrates a diagram of an example computing device 418 according to the present disclosure. The computing device 418 can utilize software, hardware, firmware, and/or logic to perform a number of functions described herein.

The computing device 418 can be any combination of hardware and program instructions configured to share information. The hardware, for example, can include a processing resource 419 and/or a memory resource 421, e.g., computer-readable medium (CRM), machine readable medium (MRM), database, etc. A processing resource 419, as used herein, can include any number of processors capable of executing instructions stored by a memory resource 421. Processing resource 419 may be integrated in a single device or distributed across multiple devices. The program instructions, e.g., computer-readable instructions (CRI), can include instructions stored on the memory resource 421 and executable by the processing resource 419 to implement a desired function, e.g., network traffic control, classification, and redirection.

The memory resource 421 can be in communication with a processing resource 419. A memory resource 421, as used herein, can include any number of memory components capable of storing instructions that can be executed by processing resource 419. Such memory resource 421 can be a non-transitory CRM or MRM. Memory resource 421 may be integrated in a single device or distributed across multiple devices. Further, memory resource 421 may be fully or partially integrated in the same device as processing resource 419 or it may be separate but accessible to that device and processing resource 419. Thus, it is noted that the computing device 418 may be implemented on a participant device, on a server device, on a collection of server devices, and/or a combination of the user device and the server device.

The memory resource 421 can be in communication with the processing resource 419 via a communication link, e.g., a path, 420. The communication link 420 can be local or remote to a machine, e.g., a computing device, associated with the processing resource 419. Examples of a local communication link 420 can include an electronic bus internal to a machine, e.g., a computing device, where the memory resource 421 is one of volatile, non-volatile, fixed, and/or removable storage medium in communication with the processing resource 419 via the electronic bus.

Modules 422, 423, and 424 can include CRI that when executed by the processing resource 419 can perform a number of functions. The number of modules 422, 423, and 424 can be sub-modules of other modules. For example, the classify module 422 and the metadata module 423 can be sub-modules and/or contained within the same computing device. In another example, the number of modules 422, 423, and 424 can comprise individual modules at separate and distinct locations, e.g., CRM, etc.

Each of the modules 422, 423, and 424 can include instructions that when executed by the processing resource 419 can function as a corresponding engine as described herein. For example, the inspection module 424 can include instructions that when executed by the processing resource 419 can function as the inspection engine 414.

In the preceding detailed description of the present disclosure, reference is made to the accompanying figures that form a part hereof, and in which is shown by way of illustration how examples of the disclosure may be practiced. The proportion and the relative scale of the elements provided in the figures are intended to illustrate the examples of the present disclosure, and should not be taken in a limiting sense. As used herein, “a number of” an element and/or feature can refer to one or more of such elements and/or features.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A non-transitory computer readable medium storing instructions executable by the computer to cause the computer to:
classify incoming network traffic to a network device based on a rate of the network traffic;
redirect the network traffic to a first network interface of a plurality of network interfaces on the network device based on the classification; and
forward the redirected network traffic to another network device via the first network interface of the plurality of network interfaces.

2. The non-transitory computer readable medium of claim 1, wherein the instructions are executable to:
redirect the incoming network traffic to the first network interface of the plurality of network interfaces in response to the incoming network traffic being classified as meeting a first network traffic rate;
redirect the incoming network traffic to a second network interface of the plurality of network interfaces in response to the incoming network traffic being classified as exceeding the first network traffic rate, and falling below a second network traffic rate; and
redirect the incoming network traffic to a third network interface of the plurality of network interfaces in response to the incoming network traffic being classified as meeting or exceeding the second network traffic rate.

3. The non-transitory computer readable medium of claim 2, wherein the first network traffic rate is a network traffic commit rate and the second network traffic rate is a peak rate.

4. The non-transitory computer readable medium of claim 1, wherein the instructions are executable to classify the incoming network traffic based on a combination of incoming network traffic header fields.

5. A system, comprising:
a classify engine to classify incoming network traffic based on a rate of the incoming network traffic using a content-addressable memory (CAM);
a metadata engine to index, using the CAM, the classified network traffic into associated metadata values; and
an inspection engine to inspect the associated metadata values and redirect the network traffic to corresponding network interfaces based on the inspection.

6. The system of claim 5, including the inspection engine to compare the associated metadata values with register values during the inspection.

7. The system of claim 5, wherein the CAM is a ternary CAM (TCAM).

8. The system of claim 5, including an action engine to apply a network policer to the incoming network traffic to monitor the incoming network traffic for compliance with a network traffic contract.

9. The system of claim 8, including the action engine to apply the network policer to enforce the network traffic contract by marking separate metadata values for network traffic conforming to the network traffic contract, network traffic exceeding the network traffic contract, and network traffic violating the network traffic contract.

10. A method for network traffic classification and redirection, comprising:
classifying incoming network traffic based on a rate of the incoming network traffic into a first incoming network traffic rate, a second incoming network traffic rate, and a third incoming network traffic rate;
generating metadata values corresponding to each of the first incoming network traffic rate, the second incoming network traffic rate, and the third incoming network traffic rate;
setting egress network interfaces, using logic, for the incoming network traffic based on the metadata values; and
redirecting the incoming network traffic to the set egress network interfaces.

11. The method of claim 10, including managing a network device housing the egress network interfaces using a network controller in communication with the network devices via a communication protocol.

12. The method of claim 10, including distributing workloads throughout a network to which the incoming network traffic was incoming.

13. The method of claim 10, wherein the metadata values are generated by a policer, and wherein:
the metadata value corresponding to the first incoming network traffic rate corresponds to a value for meeting a commit rate;
the metadata value corresponding to the second incoming network traffic rate corresponds to a value for exceeding a commit rate and falling below a peak rate; and
the metadata value corresponding to the third incoming network traffic rate corresponds to a value for exceeding a peak rate.

14. The method of claim 10, wherein the egress network interfaces allow incoming network traffic of different network bandwidths.

15. The method of claim 10, including a network controller balancing the network load in response to the redirected incoming network traffic.
